(19) United States
(12) Patent Application Publication
(10) Pub. No.: US 2023/0225391 A1
(43) Pub. Date: Jul. 20, 2023

(54) SYSTEM AND METHOD FOR FABRICATION OF A THREE-DIMENSIONAL EDIBLE PRODUCT

(71) Applicant: REDEFINE MEAT LTD., Rehovot (IL)

(72) Inventors: Daniel MANDELIK, Rehovot (IL); Eyal COMFORTI, Tel Aviv (IL); Sagee SCHACHTER, Tel Aviv (IL); Gur SHAPIRA, Kadima-Zoran (IL); Daniel DIKOVSKY, Ariel (IL)

(21) Appl. No.: 18/001,754

(22) PCT Filed: Oct. 14, 2021
(86) PCT No.: PCT/IL2021/051221

§ 371 Date: Dec. 14, 2022

(30) Foreign Application Priority Data
Oct. 14, 2020 (IL) 278059

(51) Int. Cl. A23P 20/20; B33Y 30/00; B33Y 10/00; B33Y 50/02

(52) U.S. Cl. CPC A23P 20/20; B33Y 30/00; B33Y 10/00; B33Y 50/02; A23P 2020/253

(57) ABSTRACT

The present disclosure provides a system and method for fabrication of a three-dimensional edible product having two or more edible components. The system comprises a processor configured to receive an edible product design having pattern coordinates, and to provide pattern address signals, a printing mechanism having a printing head with two or more sets of a plurality of discrete applicators, each one of the two or more sets is configured to receive and dispense a different edible component, each of said discrete applicators being configured to receive and selectively dispense, its corresponding edible component onto a printing support bed in accordance with said pattern address signals, and a driving mechanism configurable to control the position of said printing head with respect to a printing support bed.

### TECHNOLOGICAL FIELD

The present disclosure is directed to a system and a method for fabrication of a three-dimensional (3D) edible product, and more specifically, to a system and method for fabrication of a 3D edible product by a plurality of discrete applicators.

### BACKGROUND

The world population is growing, and according to FAO it is expected to be 9.6 billion up to 2050. Consequently, the demand for protein of both plant and animal origin is intended to increase. Most of the proteins of animal origin are derived from livestock, which the farming thereof contributes to global warming and also uses a significant amount of resources in comparison with proteins of plant origin. It is known that a plant-based agriculture has a much lower environmental impact with regards to freshwater use, amount of land required, and waste products generated, than agriculture for meat production. As such, increasing the amount of plant derived protein in favor of the animal derived protein is one of the main challenges of the 21^{st} century.

Today, meat substitute products are made with traditional methods and from a homogenous mixture, which does not provide the visual effect nor the texture or appeal of real meat.

### General Description

According to a first aspect of the disclosure there is a disclosed a system for fabrication of a three-dimensional edible product having two or more edible components, comprising:
(a) a processor configured to receive an edible product design having pattern coordinates, and to provide pattern address signals;
(b) a printing mechanism comprising a printing head having two or more sets of a plurality of discrete applicators, each one of the two or more sets is configured to receive and dispense a different edible component, each discrete applicator of the plurality of discrete applicators being configured to receive and selectively dispense, in a continuous or intermittent manner, its corresponding edible component onto a printing support bed in accordance with the pattern address signals received from the processor; and
(c) a driving mechanism configurable to receive said pattern address signals and to control the position of said printing head with respect to a printing support bed;

In operation, the system is configured to receive a design of a meat slab, such as an Entrecôte or Sirloin cuts, from a user or from a predefined storage module thereof, so as to fabricate the meat slab in accordance with the design. The design comprises data about the meat slab such as: desired fat content (for example, on the USDA's grading system), size of slab, fiber rigidity and the like. These settings are being translated into a 3D matrix of pattern coordinates by a controller, and accordingly, pattern address signals are sent by the controller to the printing mechanism and the driving mechanism. The printing mechanism is configured to receive pattern address signals as for which edible components are to be used in the fabrication process, instructions as for when to start and cease dispensing of each of the edible components from each of the discrete applicators of the printing head. The driving mechanism is configured to change the position of the printing head with respect to the support bed by controlling the movement of at least one of them.

In order to receive the edible components and to facilitate them towards the printing head the system can comprise a feeder mechanism. The feeder mechanism can be configured to receive two or more edible components, which can be received from various sources and can be configured to separately manipulate each edible component towards a respective set of discrete applicators.

The feeding mechanism can be configured to receive ready-for-use (i.e., off the shelf) containers of edible components. Each of the containers can have a different shape and be configured to enable extraction of the edible component therein in a different manner. For example, the containers of the edible components can be formed in a box/can like shape having a rigid cover (e.g., a can), and the edible component can be extracted therefrom by increasing the pressure within the container while enabling the pressurized material to be facilitated towards the printing head by a maneuvering system (such as a tubing system, conveyer system and the like). In other examples, the edible component can be formed as a flexible container (e.g., elongated sausage) and be provided directly to the printing head, from which it will be dispensed onto the support bed.

In other cases, the feeding mechanism can be configured to receive sources of almost-ready edible components and to complete the preparation thereof to form the ready to use form of container.

The edible components that can be received by the feeding mechanism can be in the form of liquids (such as water, blood-substitute, oil and the like), solids (such as dough), or semi-liquids (such as high-viscosity or non-Newtonian fluids).

The system can further comprise at least one splitter module interconnecting the feeding mechanism and the printing head. The splitter mechanism is configured to split the stream of edible components received thereto into a plurality of streams directed towards their respective set of discrete applicators. The splitter module comprises a body having a splitter inlet configured to receive edible component from the feeding mechanism, and a plurality of splitter outlets configured to provide edible component to each one of the discrete applicators of one of the two or more sets of a plurality of discrete applicators of the printing head.

In general, the printing head can comprise two or more sets of discrete applicators, where each of the sets is configured to receive and dispense a different edible component. More specifically, each of the discrete applicators of the set is configured to receive and dispense the edible component of the set in an independent manner from the other discrete applicators and in accordance with signals received from the controller.

The discrete applicators in the sets can have a formation with respect to each other, such that the edible component dispensed from one discrete applicator is configured to overlap with the edible component dispensed from its adjacent discrete applicator.

In some cases, the printing head can further comprise a printing plate configured to be in fluid communication with the discrete applicators of at least one of the sets along a fluid path, and to dispense edible component therefrom onto the support bed. The printing plate can be configured with outlet ports, that are configured with a predetermined position and in which each two adjacent outlet ports are closer to each other than their respective discrete applicators fluidly connected thereto to enable tighter formation of dispensed edible components onto the support bed.

According to a second aspect of the presently disclosed subject matter, there is provided a system for fabrication of a three-dimensional edible product having two or more edible components, comprising:
(a) a processor configured to receive an edible product design having pattern coordinates, and to provide pattern address signals;
(b) a printing support bed;
(c) a printing mechanism comprising a printing head configured with two or more sets of a plurality of discrete applicators, each one of the two or more sets is configured to receive and selectively dispense, in a continuous or intermittent manner, one of the two or more different edible components in a distinct manner onto the printing support bed in accordance with the pattern address signals received from the processor; and
(d) a driving mechanism configurable to receive said pattern address signals so as to control the position of the printing support bed with respect to the printing head.

In general, the driving mechanism can be configurable to control the position of the support bed with respect to the printing head, or vise versa, in accordance with the pattern signals received from the processor/controller. For that purpose, the driving mechanism can be configured with drive elements in order to maneuver the printing head and/or the support bed.

According to a third aspect of the disclosure there is a system for fabrication of a three-dimensional edible product having two or more edible components, comprising:

(a) a processor configured to receive an edible product design having pattern coordinates, and to provide pattern address signals;

(b) a printing support bed;

(c) a printing mechanism comprising a printing head having at least one set of a plurality of discrete applicators, each one of the discrete applicators is configured to receive and selectively dispense, in a continuous or intermittent manner, one of the two or more edible components in a distinct manner onto the printing support bed in accordance with the pattern address signals received from the processor; and

(d) a driving mechanism configurable to receive said pattern address signals and to control the position of said printing head with respect to the printing support bed;

wherein each discrete applicator is configured to selectively dispense, in a continuous or intermittent manner, one of the two or more edible components onto the support bed in accordance with pattern address signals received from the processor.

According to a fourth aspect of the disclosure there is a disclosed a method for fabricating a three-dimensional edible product comprising two or more edible components in accordance with pattern address signals, comprising:

(a) providing a printing support bed by which said edible product is supported while being fabricated;

(b) providing a printing mechanism comprising at least one printing head having a plurality of discrete applicators, for dispensing, in a continuous or intermittent manner, a plurality of strands of two or more different edible compositions provided to said printing mechanism onto said printing support bed, in accordance with the pattern address signals, so as to form a product layer; and

(c) operating a driving mechanism in accordance with said pattern address signals for controlling the position of said at least one printing head with respect to said printing support bed, so as to fabricate said product by depositing successive product layers on top of each other.

As used herein the term “application of edible material” relates to the action of releasing edible material from the printing head onto the printing support bed by extrusion, shutter array, or any method known to a person having skill in the art.

Any one or more of the following features designs and configurations can be utilized in any of the aspects of the present disclosure, related to the system for fabrication of a three-dimensional edible product, solely or in various combinations thereof:
the feeder mechanism can be configured to separately manipulate each edible component towards a different set of the two or more sets of discrete applicators
the feeder mechanism can comprise at least one pressurizing device;
the splitter module can be configured to provide a substantially equal flow and/or pressure from each one of its splitter outlets;
the splitter module can comprise a plurality of edible material flow paths extending between said splitter inlet and each one of the splitter outlets, wherein the diameter of each flow path increases along the flow path;
the splitter module can be configured with a compensation mechanism configured to detect pressure and/or flow parameters at the splitter outlets;
the compensation mechanism of the splitter module can be configured with a blockage removal mechanism, configured to be operated upon detection of a change in pressure parameters derived therefrom;
each one of the two or more sets of discrete applicators can be maneuvered independently from the other set by the driving mechanism;
the sets of discrete applicators can be arranged next to each other along the print axis;
the sets discrete applicators can be positioned on the printing head in an identical formation and in parallel to each other along the print axis;
the printing head can comprise two or more printing heads corresponding to the number of the sets of the discrete applicators, wherein each set is positioned on a different printing head;
the printing plate can be configured with a plurality of inlet ports associated with the outlet ports, that are configured to receive a secondary tubing elements connectable to respective discrete applicators;
each one of the discrete applicators can comprise a hollow elongated applicator body having an edible component inlet, an applicator outlet and a propelling mechanism configured to propel edible component received from the edible component inlet through the applicator outlet;
the propelling mechanism can comprise a propelling element formed as an auger snuggly fitted within said applicator body;
the propelling mechanism can comprise a propelling element formed as a Progressive Cavity Pump (PCP) within said applicator body
each one of the discrete applicators can be configured to be separately controlled by the processor;
the printing head can further be configured with a plurality of elevating motors, each associated with one of the plurality of discrete applicators and configured to elevate or lower the position of each one of the discrete applicators with respect to the printing support bed independently of one another.
the distance between each central axes of each pair of the plurality of outlet ports on the printing plate along the cross-print axis is smaller than the distance between the central axes of each respective pair of the discrete applicators fluidly connected thereto;
the printing plate can be further configured with an elevating motor associated with at least one of the sets of discrete applicators and configured to elevate or lower the position of the printing plate with respect to the printing support bed;
the driving mechanism can be configured to maneuver the printing support bed in accordance with the pattern signals received from the processor, so as to control the position thereof with respect to the printing head;
the printing support bed can be configured with a three-dimensional surface area.
the processor can be configured with a drool prevention algorithm,
wherein the drool prevention component is configured to adjust the pattern address signals in accordance with the distance of each of the discrete applicators from the splitter module;

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A is a perspective view of a system according to an example of the disclosure;

FIG. 1B is section along line A-A in FIG. 1A;

FIG. 1C is an enlargement of the portion marked 1C in FIG. 1B;

FIG. 2A is a perspective view of a system according to the example of FIG. 1A with the housing removed therefrom for illustration purposes;

FIG. 2B is a schematic presentation of the printing mechanism of the system of FIG. 2A in block diagram;

FIG. 3A is perspective view of an example of a feeding mechanism of the printing mechanism of FIG. 2A;

FIG. 3B is perspective view of another example of feeding mechanism of the printing mechanism of FIG. 2A;

FIG. 3C is perspective view of yet another example of feeding mechanism of the printing mechanism of FIG. 1E;

FIG. 4A is a perspective view of a first example of a splitter module, configured to be used with the printing mechanism of FIG. 2A;

FIG. 4B is side view of the splitter module of FIG. 4A;

FIG. 4C is an enlarged view of the section marked 4C in FIG. 4B;

FIG. 5A is a perspective view of a printing head of the printing mechanism of FIG. 2A;

FIG. 5B is a side view of the printing head of FIG. 5A with two sets of discrete applicators removed for clarity;

FIG. 5C is a perspective view of another example of a printing head of the printing mechanism of FIG. 5A;

FIG. 6A is a perspective view of a discrete applicator of the printing head of FIG. 5A;

FIG. 6B is a sectional view along line B-B in FIG. 6A;

FIG. 6C is an enlargement of the portion marked 6C in FIG. 6B;

FIG. 6D is an enlargement of the portion marked 6D in FIG. 6C;

FIG. 7A is a perspective view of a printing plate of the printing head of FIG. 5A;

FIG. 7B is a sectional view along line C-C in FIG. 7A; and

FIG. 8 is a perspective view of a printing support bed of the system of FIG. 2.

### DETAILED DESCRIPTION OF EMBODIMENTS

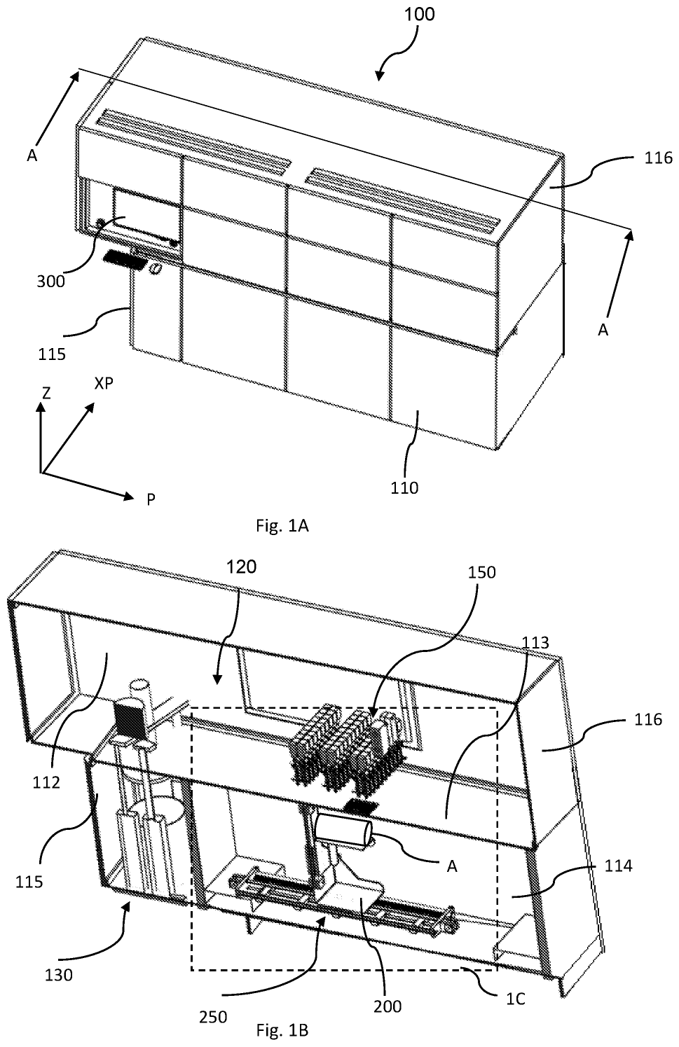

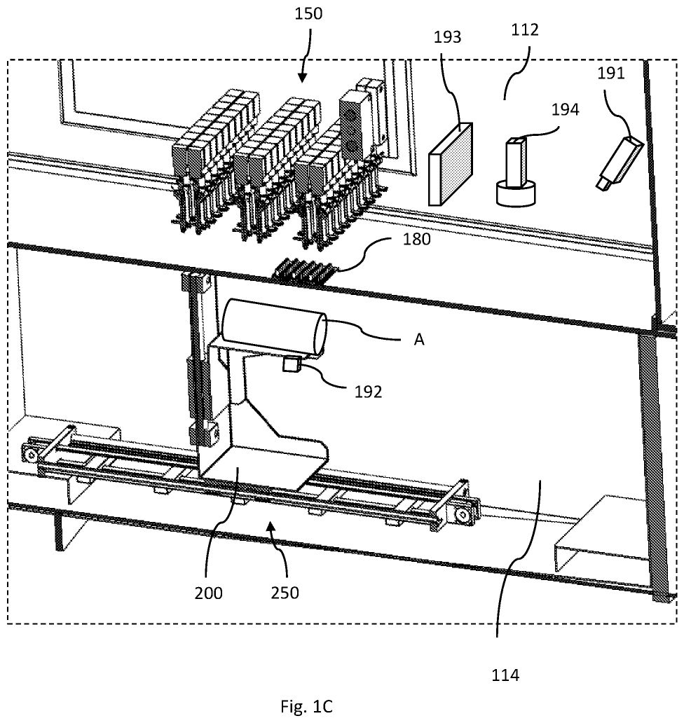

Attention is first directed to FIGS. 1A-1C illustrating a schematic view of an example of a system for fabrication of a three-dimensional edible product 100, also referred to simply as system 100 hereafter. The system 100 comprises a housing 110, a printing mechanism 120 configured to fabricate an edible product A, a printing support bed 200 configured to support the edible product A while being fabricated by the printing mechanism 120, a driving mechanism 250 and a controller 300.

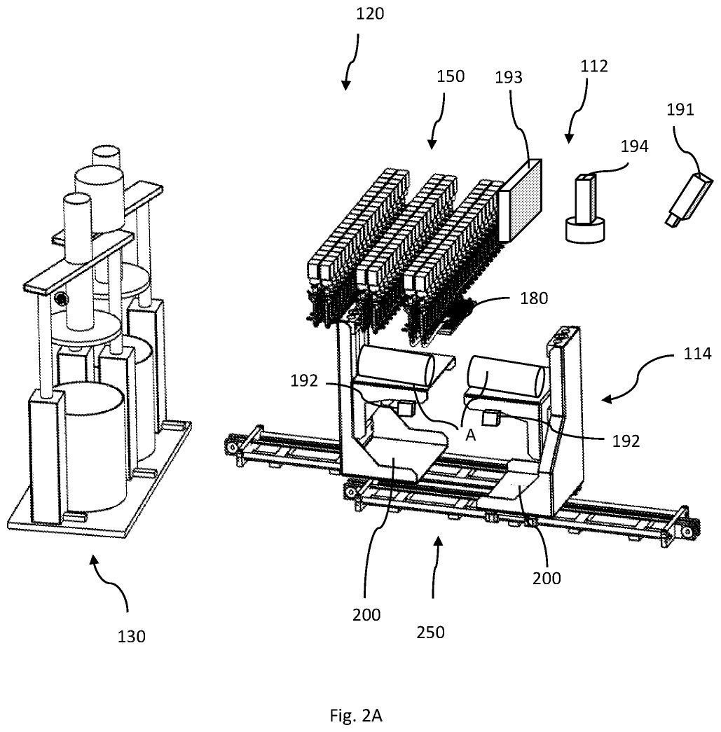

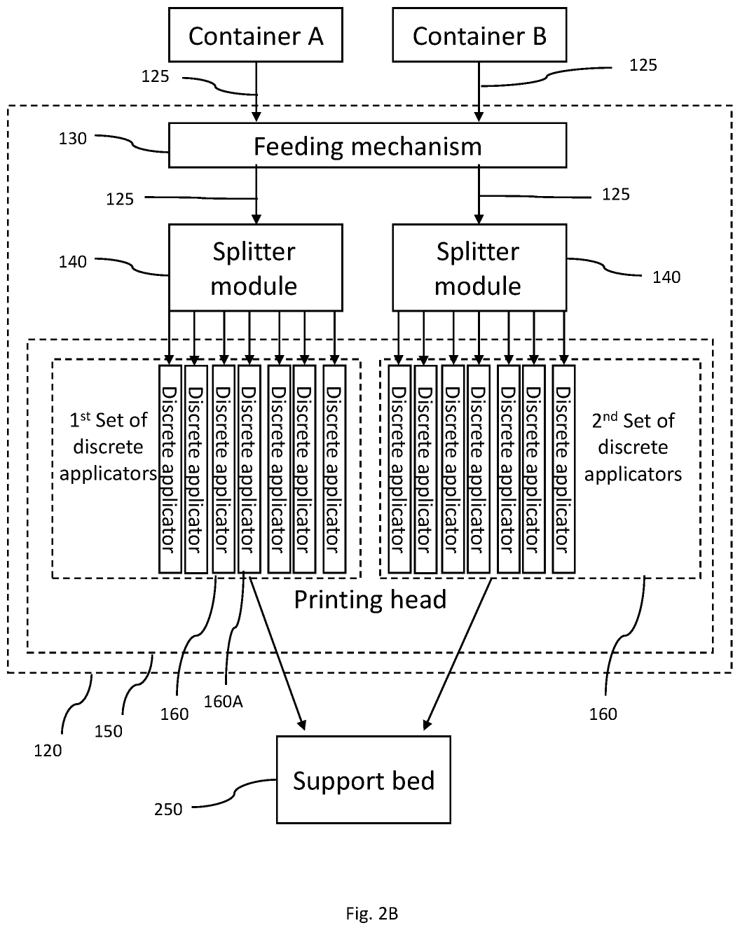

In general, the system 100 is configured to receive at least two edible components, and to fabricate thereby the edible product A by the printing mechanism 120. The printing mechanism 120 can be configured to receive and dispense each of the edible components in a separate manner on the printing support bed 200, which can be integral to or integrated with the system 100. In some cases, as illustrated in FIG. 2A, the printing mechanism 120 can comprise two or more sets of discrete applicators in order to receive and dispense, in a separate manner, each of the edible components so as to fabricate a product layer. The fabrication process of the product layer is configured to occur in a repeatable manner, layer on top of layer, such that each layer is fabricated on top of a preceding layer. The system 100 is also configured to receive, by the controller 300 thereof, an edible product design, and to provide pattern address signals to the printing mechanism 120 in accordance to which each of the edible components is fabricated by the printing mechanism in a time dependent manner so as to form each layer, and thereby the product.

In an example of the present invention, the housing is formed as an elongated cube comprising a longitudinal print axis P, a latitudinal cross-print axis XP and a height axis Z. The print axis P is the axis along which the edible product A is mainly fabricated, and on which long fibers of edible component mimicking the fibers of a real meat slab are dispensed. In another example of the present example (not illustrated), the housing 110 can be formed as a circular chamber and can comprise a circular print axis P, a radial cross-print axis XP and a height axis Z. In such example, the printing mechanism can be positioned at the center and the printing support bed can be formed in a ring shape encompassing the printing mechanism.

In a first example of the disclosure shown in FIGS. 1A-1C, housing 110 comprises a mechanical portion 112, in which the printing mechanism 120 is positioned, and a fabricating portion 114, in which the printing support bed 200 is positioned. The housing 110 is configured to provide suitable conditions for manufacturing foodstuff products, such as controlled temperature, filtration mechanism, smooth surfaces and the like. In some cases, the mechanical portion 112 and the fabricating portion 114 are isolated from each other by a barrier 113, through which a portion of the printing mechanism 120 sealingly protrudes to the fabricating portion 114 in order to fabricate the edible product.

The housing 110 is configured with a component receiving end 115, through which a user may provide sources of edible components for the printing mechanism 120, and a product releasing end 116, through which the fabricated edible products A can be withdrawn. Although the housing 110 is shown in a rectangular box-like geometry, other configurations could be used.

In general, the system can also comprise one or more subsystems within the housing configured to perform multiple operations, either during the fabrication process or at the end thereof. Such operations can comprise dispensing solids or fluids containing color additives, spices, ‘blood’-like substitute and other food additives on the slab. The same subsystems can be configured to dispense the food additives on the slab in a plurality of methods such as spraying, dispersing and the like.

In the present example, the system can include the following subsystems:
A sensing unit 191 (e.g., camera) configured to capture data in the form of photos/videos, transmit and/or process the data for enabling a user/controller to perform a quality control of the fabrication process;
An integrated weighing system 192 for monitoring the weight of the printed product, such weighing system 192 can be positioned on the printing support bed 200 to measure the weight of the product during and after the fabrication process;
an air conditioning unit 193 configured to maintain a suitable temperature within each of the housing compartments and/or configured to applicate bursts of heating or cooling; and
an additive dispensing unit 194, configured to dispense a plurality of food additives on the product, either during or after the fabrication process.

The printing mechanism 120, the printing support bed 200 and the driving mechanism 250 of the system 100 are illustrated, at different formations and combinations thereof, in FIGS. 2A-2B, with the housing 110 omitted therefrom for illustration purposes. In the embodiment shown in FIG. 2A the fabricating portion 114, contains two printing support bed 200 parallelly driven by driving mechanism 250. Such arrangement allows printing and post fabrication processing to take place in concurrently, as will be discussed further below.

As schematically shown in FIG. 2B, the printing mechanism 120 comprises a feeding mechanism 130, and a printing head 150 having two or more sets of discrete applicators 160 in fluid communication with the feeding mechanism 130. The printing head 150 is configured to dispense the two or more edible components received from the feeding mechanism 130 onto the printing support bed.

In general, the feeding mechanism 130 can be located either within the mechanical portion 112 of the housing or external thereto, and is configured to receive two or more sources (i.e., containers) of edible components. The feeding mechanism 130 can comprise at least one pressurizing element or propelling element, configured to facilitate movement of the edible component towards the printing mechanism. In further cases, the feeding mechanism can comprise a pressurizing element for each edible component container. In other embodiments (not shown), the feeding mechanism 130 can comprise as many pressurizing elements such that each discrete applicator of the two or more sets of discrete applicators 160 is configured with its respective pressurizing element. The feeding mechanism 130 can be configured to receive solid and liquid edible components. In some cases, the feeding mechanism can be configured to receive and release liquid edible component into solid edible component to increase the hydration percentage thereof.

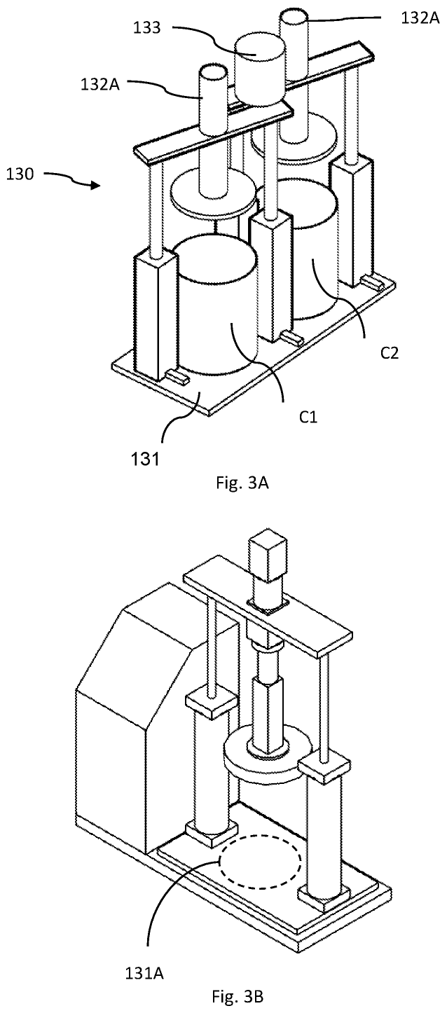

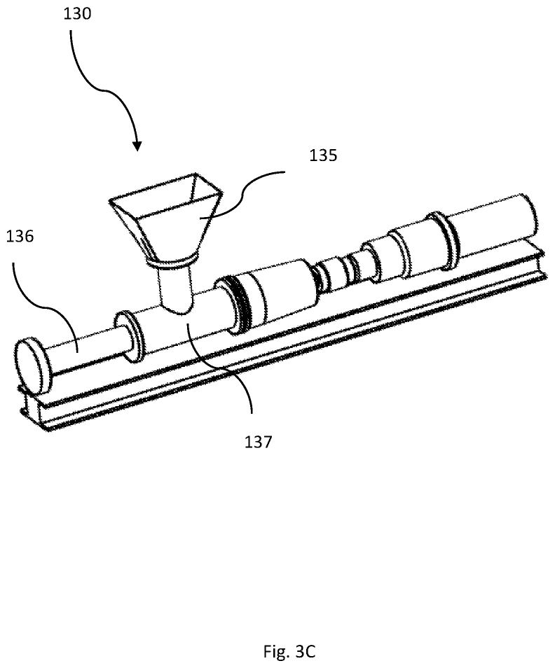

In the present example, best illustrated in FIGS. 3A and 3B, the feeding mechanism 130 is configured with a receiving base 131, which is configured to receive and secure at least one source of an edible component, and in the present example containers C1 and C2 illustrated in FIG. 3A. For that purpose, the receiving base 131 can be configured with source positioning portion 131A, that is configured to provide position indication to the position in the feeding mechanism 130 in which optimal usage of the edible components stored in the containers can be achieved. As shown, the feeding mechanism 130 comprises a first and a second pressurizing elements 132A and 132B that are configured to induce pressure in their respective. The first and a second pressurizing elements 132A and 132B are illustrated as press mechanisms each having a cylinder 133 and a piston 134 having a disc shape and configured to be pressed by the cylinder into containers C1 and C2. In other examples, the first and a second pressurizing elements 132A and 132B can be formed with any other pressure inducing devices known to a person having skill in the art. The pressure applied by each of the first and a second pressurizing elements 132A and 132B is configured to facilitate a stream of edible component from its respective container towards the printing head 150 which is fluidly connected to the feeding mechanism 130 via a tubing system 125 (schematically shown in FIG. 1B).

In some cases, the feeding mechanism 130 can be configured with a flexible pressurizing element (not shown), that is configured to induce pressure inside containers that do not fit within the container receiving base 131.

In another example illustrated in FIG. 3C, the feeding mechanism 130 is configured to receive ingredients forming an edible components or ready to use edible components. For that purpose, the feeding mechanism comprises a feeding inlet 135, configured to receive ingredients or ready to use edible component and a pressurizing element 136 configured to apply pressure inside feeding mechanism 130 as to facilitate the edible component towards the printing head 150. Optionally, feeding mechanism may also include a processing unit 137 which receives the ingredients forming edible component via the feeding inlet 135 and completes the preparation thereof to create ready to use edible component. In such case, pressurizing element 136 is configured to apply pressure inside the processing unit 137 so as to facilitate the edible component generated at the processing unit 137 towards the printing head 150.

In general, the pressurizing elements can be customized for each specific edible component intended to be used during the fabrication process, and for a plurality of containers in which they arrive. It should be emphasized that in the present example, at least one of the edible component is configured with high-viscosity properties as detailed in publication No. PCT/IL2020/050099 of the applicant, which is hereby incorporated by reference. In some cases, each of the pressurizing elements can be configured to induce and maintain a pressure of about 50 Bar, preferably 10-40, and more specifically, about 20-30 Bar in the tubing system.

The tubing system is configured to facilitate the edible component inside the printing mechanism 120 towards the sets of discrete applicators of the printing head. In some cases, the tubing system can be further configured to control the temperature of the edible component facilitated therein. In order to provide each of the discrete applicators with equally pressurized edible component, which in some cases, is less than the pressure provided by the feeding mechanism 130. For that purpose, the printing mechanism 120 can further comprise a splitter module 140, that is configured to receive a single pressurized stream of edible component and to provide a plurality of pressurized, or less pressurized, streams of the edible component.

In general, the printing mechanism can comprise a splitter module for each of the two or more sets of discrete applicators. Each splitter module can fluidly interconnect the tubing arriving from the feeding mechanism to the printing head. in some cases, each splitter module can comprise a splitter body having a splitter inlet configured to receive pressurized edible component from the feeding mechanism and a plurality of splitter outlets configured to release said sub-streams of edible component out from the splitter module and towards the printing head. In some cases, all of the sub-streams provided from the splitter outlets can have about same pressure and flow rate.

As used herein the term “about” relates to a change of up to 10% from the corresponding property to which it relates. In other cases, the pressure can be reduced inside the splitter and be omitted therefrom in a reduced pressure. In yet other cases, the pressure can be increased inside the splitter module and be omitted therefrom in an increased pressure.

In some cases, the splitter outlets can be constituted from a plurality of branching tubes, extending from the splitter inlet itself or from another branching tubes, either of same size or larger).

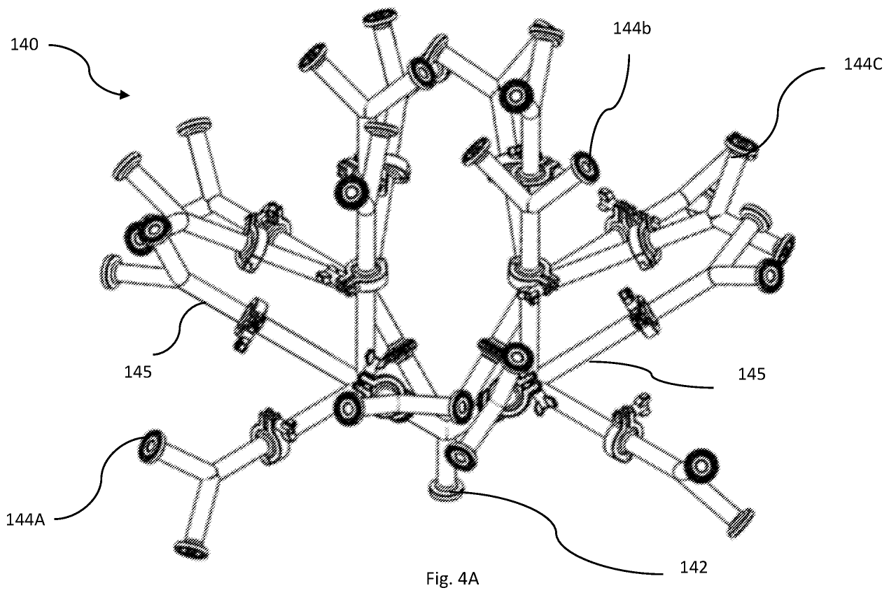

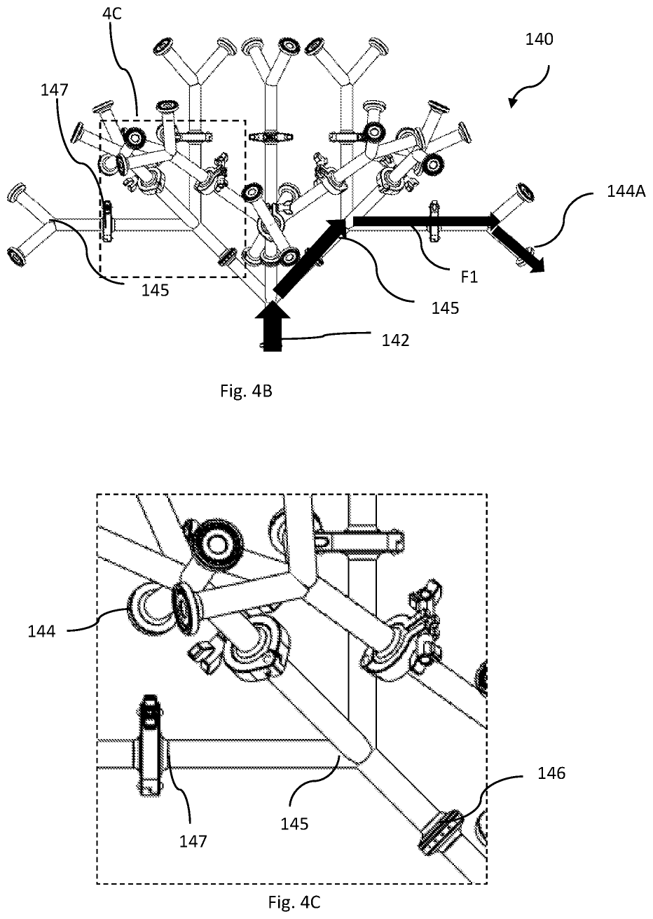

In an example of the splitter module disclosed in FIGS. 4A-4C, the splitter 140 is formed in a similar manner to a flower bouquet having a single splitter inlet 142 (as the trunk) and a plurality of splitter outlets 144 branching therefrom. The splitter 140 comprises a plurality of edible material flow paths, identical to the number of splitter outlets 144, for example, F1 extends between the splitter inlet 142 to splitter outlet 144A.

The splitter 140 of the present example is further configured with a plurality of branching tubes 145 extending between the splitter inlet 142 and the splitter outlets 144. Each of the branching tubes 145 is configured with a proximal receiving end 146 constituted as the splitter inlet 142 or configured to be connected to a preceding branching tube 145, and two or more releasing ends 147 at a distal end thereof, branching off in an identical manner from the receiving end 146. In some cases, the number of branching tubes 145 tubes along each edible material flow path may. The plurality of branching tubes 145 can vary in their diameters. In some cases, the receiving end 146 is configured with a diameter larger than the diameter of the releasing ends 147, thereby forming branching tubes 145 of different sizes that are configured to split the received stream of edible component into narrower and narrower streams of equal pressure and release said streams from the splitter outlet 144.

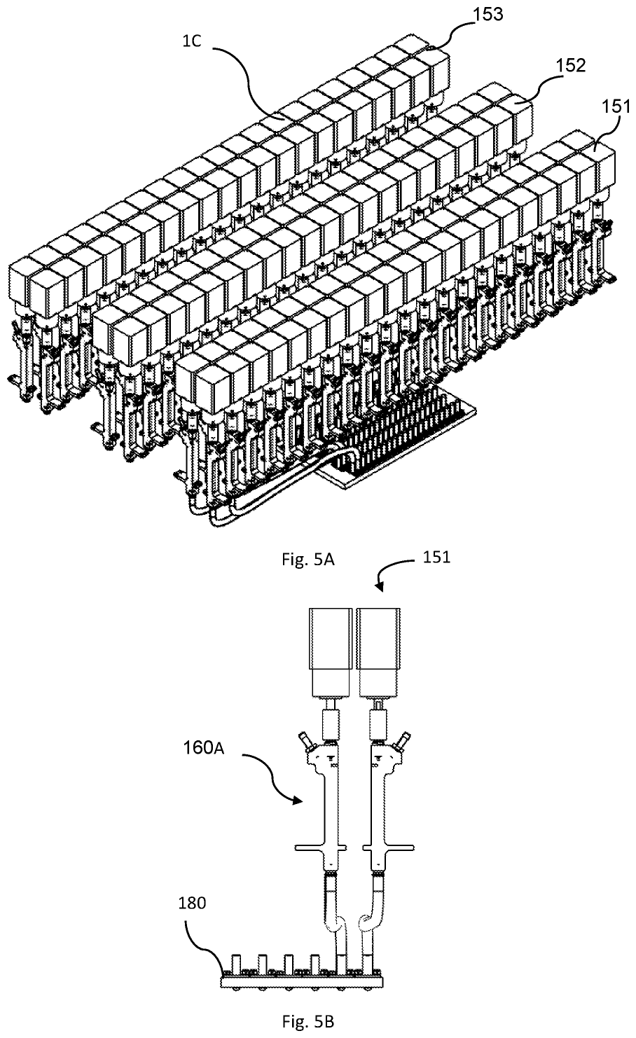

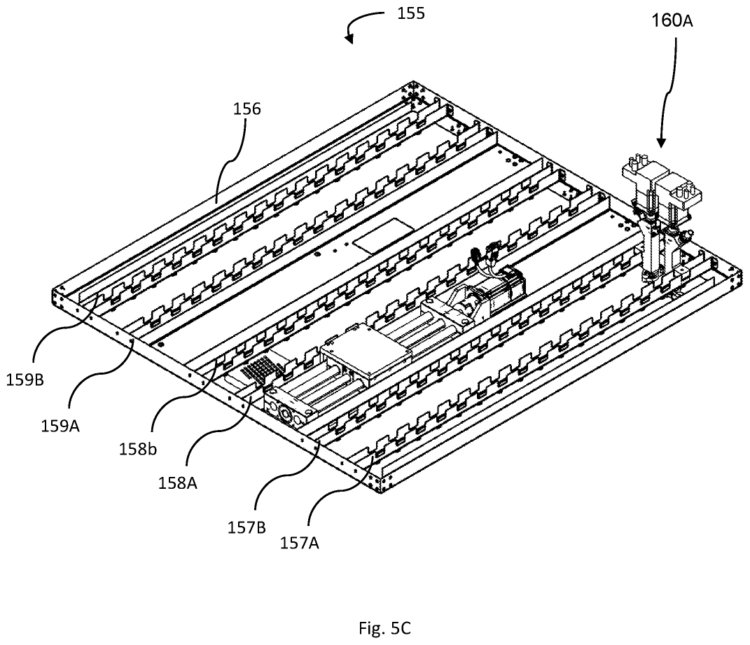

Attention is now drawn to FIGS. 5A to 5B, illustrating an example of the printing head 150 of the present disclosure. In general, the printing head 150 is configured to be in fluid communication with the feeding mechanism 130 via the tubing system 125 and is configured to receive at least two streams of edible components therefrom. The printing head 150 can comprise two or more sets of discrete applicators 160. Each of the two or more sets 160 comprises a plurality of discrete applicators 160A. Each set of discrete applicators 160 is configured to receive a stream, or more specifically, a plurality of streams, of edible component received from splitter 140 to the corresponding discrete applicators 160A. Also, each of the discrete applicators 160A of the two or more sets 160 can be configured to dispense/apply the different edible component onto the printing support bed 200 in accordance with signals received from the controller 300. In some cases, the discrete applicators 160 of each of the sets of discrete applicators can be configured differently from each other to enable optimal edible material application conditions.

In some cases, the discrete applicators 160A can be configured to add liquid edible component during the application of the edible component therefrom so as to increase the hydration of the fabricated edible product and/or to trap liquids therein to form juice effect. In some cases, the discrete applicators 160A can be configured with a slicing element configured to cut off the stream of edible component applicated from each of the applicators. The slicing element can be a plurality of slicing elements associated with each of the discrete extruders or a single slicing element associated with the entire set.

In the present example, the printing head 150 comprises a first, a second and a third sets of discrete applicators 151, 152 and 153, each of which is fluidly connected to the feeding mechanism 130 which provides a different edible component to each set. Each of the sets of discrete applicators 151, 152 and 153 comprises identical number of discrete applicators 160A, which are arranged in the same formation in an identical manner and in parallel to each of the other sets. In other cases, each of the sets of discrete applicators 151, 152 and 153 can include a different number of discrete applicators than the others.

In some cases, the discrete applicators 160A of each one of the sets of discrete applicators 151, 152 and 153 are arranged one next to each other in two rows, being indented to each other. In such cases, the discrete applicators are configured to dispense the edible component such that the fabricated edible component is in contact communication with the fabricated edible component of its adjacent discrete applicator to prevent spaces in the product layer.

In accordance with some examples of the present disclosure, the printing head 150 can further comprise a scaffold holder 155 (shown in FIG. 5C). The scaffold holder 155 comprises an external frame 156, which can be configured to be firmly connected to the housing 110, and two or more pairs of fixing strips, each matching a set of discrete applicators disposed in parallel to each other along the length of the frame. In other cases (not illustrated), the scaffold holder can be movably connected to the housing by an articulated arm, enabling it to be maneuvered with respect to the printing bed and/or to other printing heads (if any).

In general, each set of discrete applicators 160 can comprise (in its homogeneous configuration) different types of discrete applicators. Each of which is adapted to fabricate the specific edible component received thereby. In other cases, each discrete applicator 160A can be configured to fabricate many types of different edible components.

In the present example, each one of the discrete applicators 160A comprises an elongated body 161 having a central axis Y extending along the length thereof and having a propelling mechanism 170 operably connected thereto. The elongated body 161 comprises a shaft 164 extending therein along the vertical axis Y and having a top opening 164A and a bottom opening 164B. The elongated body 161 further comprises an edible component inlet 165 positioned about a top end 162 of the shaft 164 being in fluid communication with the shaft 164 and an applicator outlet 166 positioned at a bottom end 163 of the shaft 164 (i.e., constituting the bottom opening 164B).

In general, the propelling mechanism 170 can be configured to receive pattern address signals from the controller 300 and operate on the elongated body 161 accordingly, so as to propel edible component received from the edible component inlet 165 towards and outwards from the bottom opening 164B of the shaft 164.

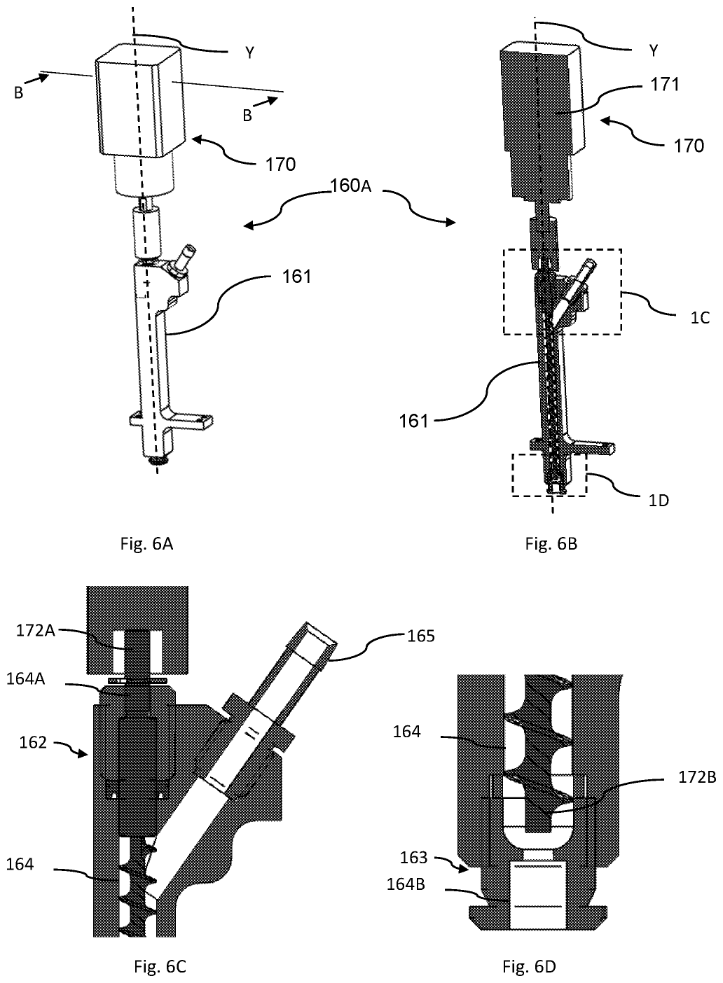

In the present example, the propelling mechanism 170 of each discrete applicator comprises a propelling engine 171 and a propelling element 172 having an actuated end 172A operably connected to the propelling engine 171 and a propelling portion 172B, configured to snuggly fit within the shaft 164. The propelling element 172 can be formed, for example, as an auger pump or a progressive cavity pump (PCP). In a specific example illustrated in FIGS. 6A-6D, the propelling element 172 is formed as an auger bit, snuggly fitted within said shaft 164.

In general, the fluid path between the feeding mechanism 130 and the bottom opening 164B of the shaft 164 can be uninterrupted by valves or shutters disrupting the flow of the edible component. As such, the shaft 164 and the propelling element 172 can be configured with certain properties in order to induce a predetermined amount of friction within the shaft 164 of each discrete applicator 160A, so as to precisely control the flow of edible component dispensed therefrom. In some cases, the shaft 164 can have a relatively small diameter and a sufficient length, such that the fluid path extending around/about the propelling element 172, from the edible component inlet 165 to the applicator outlet 166, is designed/configured to provides the sufficient amount of friction in order to arrest flow of said edible component arriving from the fluid inlet 165 without further propelling of the propelling element 172.

In the present example, the propelling element 172 is an auger pump comprising an inner diameter in the range of 5-12 mm and specifically 9 mm, a spin rate of 1 to 4 and length in the range of 35 mm to 100 mm.

In some cases, the bottom opening 164B of the shaft 164 can be configured with a drool prevention element (not shown), configured to cease further application of the edible component after receiving such signal from the controller 300. Such cases can occur when the length between each discrete applicator and the splitting module and/or feed mechanism is different, or that there is not enough vacant space in the shaft 164 for the edible component to be arrested by the friction thereof. such drool prevention element can be a shutter installed on the bottom opening 164B of the shaft 164, or a controller that is configured to arrange the timing of the signals sent to the printing mechanism 120 while taking into consideration the duration of the application of edible material, the distance of the applicator from the feed mechanism and the like.

In an example of the present disclosure, the discrete applicators may be configured with a certain diameter such that no contact exists between the edible product that is dispensed therefrom and the edible product that is dispensed from its adjacent discrete applicator. In such cases (along with other cases), the printing head can comprise an intermediate element, fluidly connected by tubes to each discrete applicator of the at least one set, and having smaller dimensions than the applicator along the XP axis (such that long fibers of edible component can be fabricated, while being in contact with each other).

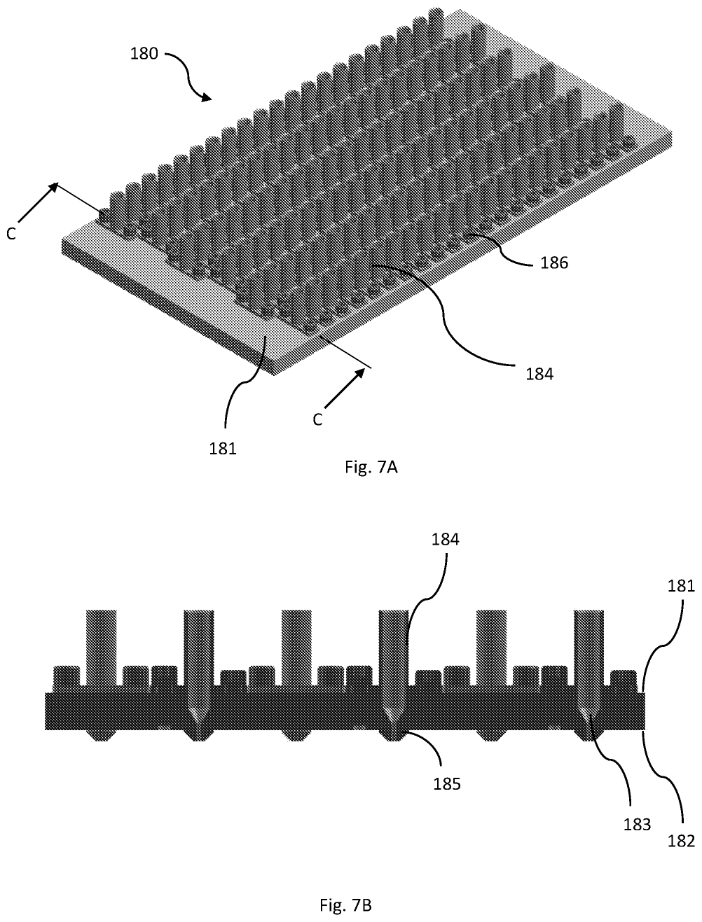

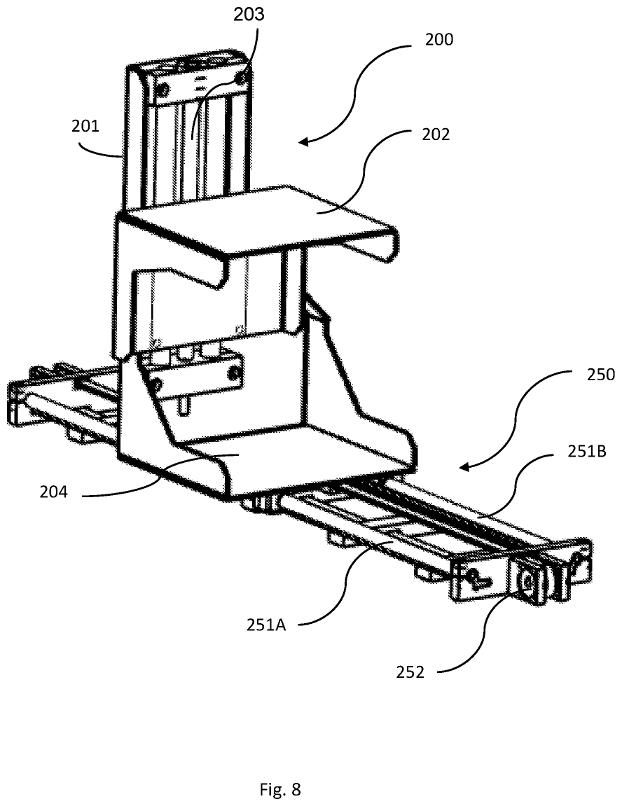

In the present example, the printing plate 180, as best illustrated in FIGS. 1C, 7A and 7B, comprises an inlet surface 181, an outlet surface 182 and a plurality of apertures 183 transversing the plate from the inlet surface 181 to the outlet surface 182. The apertures are configured with inlet ports 184 at the inlet surface 181 side thereof to which the printing head 150 is fluidly connected via a secondary tubing elements. In some cases, two applicators of the printing head 150 can be fluidly connected to the same inlet port 184. In some cases, at least one applicator can be connected to two or more inlet ports 184.

The apertures are also configured with outlet ports 185 at the outlet surface 182 side thereof from which edible product can be fabricated onto the printing support bed 200. As shown, each inlet ports 184 is fixedly connected to the printing plate 180 by screws 186.

In some cases, the apertures 183 of the printing plate can be arranged in several arrays, each of which can be configured with a different diameter to fit the edible component that is configured to be fabricated therethrough. in some cases, a single discrete applicator can be fluidly connected to two or more inlet ports 184. For example, the three lateral inlet ports on each lateral side can be fluidly connected to a single discrete applicator since they are configured to fabricate a wall portion of the meat slab, which always fabricated from the same material entirely.

In some cases, the distance between each pair of the plurality of apertures 183 on the printing plate 180, at least along the XP axis, is configured to be smaller than the distance between the central axes Y of each respective pair of the discrete applicators 160 fluidly connected thereto.

In some cases, each of the discrete applicators 160 or their respective outlet ports 185, can further comprise an elevating motor (not shown) configured to draw near or to distance it from the printing support bed 200 independently of one another.

In general, the printing support bed 200 can be configured to support, retain and/or hold the edible product A or an object onto which edible product A can be fabricated. For that purpose, the printing support bed 200 can be moveable with respect to the printing mechanism 120. The printing support bed 200 can be constituted by two printing support beds 200, as shown in FIG. 2A such that when the printing head 150 fabricates edible components on a first printing support bed positioned at least partly underneath the printing head 150, a second printing support bed can enable post processing of edible components fabricated thereon earlier away from the printing head 150.

In the present example, the printing support bed 200 comprises a bed surface 202, which can move with respect to the printing head 150 by the driving mechanism 250 and in accordance with signals received from the controller 300. For example, the bed surface 202 can be configured to maneuver along the P axis and the Z axis, while the printing head 150 is configured to be maneuvered along the XP axis by the driving mechanism 250. In some cases, the bed surface 202 can be configured to rotate and/or tilt about one or more axes associated with the bed surface 202. Thus, it is contemplated that in at least some embodiments, the bed surface 202 may be moved into any desired relative configuration with the printing head 150. For that purpose, the printing support bed 200 comprises a bed body 201, to which the bed surface 202 is operably connected by an adjusting mechanism 203, configured to enable the printing support bed the aforementioned movements. The bed body 201 is further configured with a moveable portion 204 configured to be moved by the driving mechanism 250.

In general, the driving mechanism 250 is configured to maneuver the printing support bed 200 relative to the printing head 150. As would be apparent for the skilled in the art, this may be achieved by moving printing head 150 relative to support bed 200, moving support bed 200 relative to printing head 150 or any combination thereof (e.g., in the drawn embodiment of FIGS. 1B, 1C in Cartesian coordinated-support bed 200 moves in P and Z direction and printing head 200 move in XP direction). For that purpose, the driving mechanism 250 can be in electrical communication with the controller 300 for receiving pattern signals therefrom so as to control the movement of either the printing support bed 200 or the printing head 150. In further cases, the driving mechanism 250 can be configured to maneuver the printing plate relative to the set of discrete applicators connected thereto. The relative position of the printing support bed 200 relative to the printing head can be achieved using either a Cartesian and/or cylindrical axes system.

In the present example, the driving mechanism 250 comprises a railing module 251 comprising two rails 251A and 251B, extending in parallel to each other and inverted to each other. The two rails 251A and 251B extend from at least beneath the printing head 150, each towards its respective opposite lateral ends of the housing 110. In the embodiment shown in FIG. 2A driving mechanism 250 includes two separate pairs of rails 251A and 251B, each pair carries one of the support beds 200. The driving mechanism 250 comprises an engine 252, configured to move the moveable portion 204 of a respective printing support bed 200 on its respective rail from a fabrication position, in which the printing support bed is positioned at least somewhat underneath a portion of the printing head (such as the printing plate 180) to a post processing position, in which any fabricated material dispensed on the bed surface 202 is allowed to be cured.

As discussed above, the system 100 comprises the controller 300 which is configured to receive and provide information to and from a user, either local or remote and/or controller from and to the printing mechanism 120. The controller 300 can include a processor 310 and a communication module 320. Generally, the term “processor” refers to the computing resources of a single computer, a portion of the computing resources of a single computer, and/or two or more computers in communication with one another. Any of these resources can be operated by one or more users. In some cases, the controller 300 can include one or more interfaces, for example, the controller can comprise a print server responsible for providing pattern address signals for the printing head 150, the driving mechanism 250 and the printing support bed 200, while a separate interface, either locally or remotely in communication with the print server (e.g., desktop, laptop or tablet) may allow a user to provide edible product designs to the system 100. The controller 300 can also include one or more storage modules for storing edible product designs received by the system.

1-36. (canceled)

37. A system for fabrication of a three-dimensional edible product having two or more edible components, the system comprising:
(a) a processor configured to receive an edible product design having pattern coordinates, and to provide pattern address signals;
(b) a printing mechanism comprising a printing head having two or more sets of a plurality of discrete applicators, each one of the two or more sets is configured to receive and dispense a different edible component, each discrete applicator of the plurality of discrete applicators being configured to receive and selectively dispense, in a continuous or intermittent manner, a corresponding edible component thereof onto a printing support bed in accordance with the pattern address signals received from the processor; and
(c) a driving mechanism configurable to receive said pattern address signals and to control the position of said printing head with respect to a printing support bed.

38. The system of claim 37, further comprising a feeder mechanism configured to receive two or more edible components from different sources and to separately manipulate each edible component towards a respective printing head.

39. The system of claim 38, wherein the feeder mechanism is configured to separately manipulate each edible component towards a different set of the two or more sets of discrete applicators.

40. The system of claim 38, wherein at least one of the different sources comprises a readily available edible component contained within a container, wherein the feeder mechanism is configured to induce pressure within the container to manipulate the edible component contained therein outwards therefrom and towards its respective printing head.

41. The system of claim 38, wherein the two or more sources of a different edible component are constituted by at least one pre-fabrication module associated with the feeder mechanism and configured to receive ingredients and process said ingredients into the two or more edible components.

42. The system of claim 38, wherein the feeder mechanism comprises at least one pressurizing device.

43. The system of claim 37, further comprising at least one splitter module having a splitter inlet configured to receive edible component, and a plurality of splitter outlets configured to provide edible component to each one of the discrete applicators of one of the two or more sets of a plurality of discrete applicators.

44. The system of claim 43, wherein the splitter module is configured to provide a substantially equal flow or pressure from each one of its splitter outlets.

45. The system of claim 44, wherein the splitter module comprises a plurality of edible material flow paths extending between said splitter inlet and each one of the splitter outlets, wherein the diameter of each flow path increases along the flow path.

46. The system of claim 37, wherein each of the two or more sets of discrete applicators can be maneuvered independently from the other sets.

47. The system of claim 37, wherein each of the sets of discrete applicators are arranged next to each other along the print axis.

48. The system of claim 37, wherein each of the sets of the plurality of discrete applicators are positioned on the printing head in an identical formation and in parallel to each other along the print axis.

49. The system of claim 37, wherein the printing head comprises two or more printing heads corresponding to the number of the sets of the discrete applicators, wherein each set is positioned on a different printing head.

50. The system of claim 37, wherein the printing head further comprises at least one printing plate, each printing plate is configured with an inlet surface and an outlet surface and a plurality of apertures transversing the plate from the inlet surface to the outlet surface, wherein each one of the apertures is in flow communication, via the inlet surface, to one of the plurality of the discrete applicators, so as to enable manipulation of edible component therefrom.

51. The system of claim 37, wherein each one of the discrete applicators comprises a hollow elongated applicator body having an edible component inlet, an applicator outlet and a propelling mechanism disposed therein configured to propel edible component through the applicator outlet.

52. The system of claim 51, wherein said propelling mechanism comprising a propelling element formed as any one of: an auger snuggly fitted within said applicator body or a progressive cavity pump fitted within said applicator body.

53. The system of claim 37, wherein each one of the discrete applicators is configured to be separately controlled by the processor.

54. The system of claim 37, wherein the printing head is further configured with a plurality of elevating motors, each of which is associated with one of the plurality of discrete applicators and configured to elevate or lower the position of each one of the discrete applicators with respect to the printing support bed independently of one another.

55. The system of claim 37, wherein the driving mechanism is configured to maneuver the printing support bed in accordance with the pattern address signals received from the processor, so as to control the position thereof with respect to the printing head.

56. The system of claim 37, further comprising at least one subsystem for operating a post-fabrication operation on said three-dimensional edible product.

57. The system of claim 56, wherein the at least one subsystem is configured to operate the post-fabrication operation either during the fabrication process or after the fabrication process.

58. A method for fabricating a three-dimensional edible product comprising two or more edible components in accordance with pattern address signals, the method comprising:
(a) providing a printing support bed by which said edible product is supported while being fabricated;
(b) providing a printing mechanism comprising a printing head having two or more sets of a plurality of discrete applicators where each one of the two or more sets is configured to receive and dispense a different edible component;
(c) dispensing, in a continuous or intermittent manner, a plurality of strands of two or more different edible compositions provided to said printing mechanism onto said printing support bed, each strand being dispensed by a different set of the two or more sets in accordance with the pattern address signals, so as to form a product layer; and
(c) operating a driving mechanism in accordance with said pattern address signals for controlling the position of said printing head with respect to said printing support bed so as to fabricate said product by depositing successive product layers on top of each other.

59. A system for fabrication of a three-dimensional edible product having two or more edible components, the system comprising:
(a) a processor configured to receive an edible product design having pattern coordinates, and to provide pattern address signals;
(b) a printing support bed;
(c) a printing mechanism comprising a printing head having at least one set of a plurality of discrete applicators, each discrete applicator of the plurality of discrete applicators being configured to receive and selectively dispense, in a continuous or intermittent manner, one of the two or more edible components in a distinct manner onto the printing support bed in accordance with the pattern address signals received from the processor; and
(d) a driving mechanism configurable to receive said pattern address signals from and to control the position of said printing head with respect to the printing support bed.
